(19) United States
(12) Patent Application Publication
(10) Pub. No.: US 2013/0016186 A1
(43) Pub. Date: Jan. 17, 2013

(54) METHOD AND APPARATUS FOR CALIBRATING AN IMAGING DEVICE

(71) Applicants: Kalin Mitkov Atanassov, San Diego, CA (US); Sergiu R. Goma, San Diego, CA (US); Vikas Ramachandra, San Diego, CA (US)

(72) Inventors: Kalin Mitkov Atanassov, San Diego, CA (US); Sergiu R. Goma, San Diego, CA (US); Vikas Ramachandra, San Diego, CA (US)

(73) Assignee: QUALCOMM INCORPORATED, San Diego, CA (US)

(21) Appl. No.: 13/491,033

(22) Filed: Jun. 7, 2012

Related U.S. Application Data
(60) Provisional application No. 61/507,407, filed on Jul. 13, 2011.

(51) Int. Cl. H04N 17/00

(52) U.S. Cl. 348/47; 348/E17.002

(57) ABSTRACT

Described are methods and apparatus for adjusting images of a stereoscopic image pair based on keypoint matches. The quality of the key point matches is first evaluated to determine whether the quality exceeds a keypoint quality threshold. If the quality level of the keypoint matches exceeds the threshold, the vertical disparity between the images of the stereoscopic image pair can be evaluated based on vertical disparity vectors between the keypoint matches. If the vertical disparity is below a threshold, no adjustment of the stereoscopic image pair may be performed. If the vertical disparity is above the threshold, an affine correction may compensate for pitch, roll, and scale differences between the images. A projective correction may compensate for yaw differences. The vertical disparity between the two images is then evaluated after the corrections to determine if additional adjustment should be performed.

### CROSS-REFERENCE TO RELATED APPLICATIONS

The disclosure claims priority to U.S. Provisional Patent Application No. 61/507,407 filed Jul. 13, 2011, entitled “UNASSISTED 3D CAMERA CALIBRATION,” and assigned to the assignee hereof. The disclosure of this prior application is considered part of, and is incorporated by reference in, this disclosure.

### TECHNICAL FIELD

The present embodiments relate to imaging devices, and in particular, to methods and apparatus for the automatic calibration of imaging devices.

### BACKGROUND

In the past decade, digital imaging capabilities have been integrated into a wide range of devices, including digital cameras and mobile phones. Recently, the ability to capture stereoscopic images with these devices has become technically possible. Device manufacturers have responded by introducing devices integrating multiple digital imaging sensors. A wide range of electronic devices, including mobile wireless communication devices, personal digital assistants (PDAs), personal music systems, digital cameras, digital recording devices, video conferencing systems, and the like, make use of multiple imaging sensors to provide a variety of capabilities and features to their users. These include not only stereoscopic (3D) imaging applications such as 3D photos and videos or movies, but also higher dynamic range imaging and panoramic imaging.

Devices including this capability may include multiple imaging sensors. For example, some products integrate two imaging sensors within a digital imaging device. These sensors may be aligned along a horizontal axis when a stereoscopic image is captured. Each camera may capture an image of a scene based on not only the position of the digital imaging device but also on the imaging sensors physical location and orientation on the camera. Since some implementations provide two sensors that may be offset horizontally, the images captured by each sensor may also reflect the difference in horizontal orientation between the two sensors. This difference in horizontal orientation between the two images captured by the sensors provides parallax between the two images. When a stereoscopic image pair comprised of the two images is viewed by a user, the human brain perceives depth within the image based on the parallax between the two images.

While stereoscopic imaging devices may be designed to produce stereoscopic image pairs with a given amount of horizontal offset or parallax between two images, other differences in orientation between the two images may also be introduced. For example, manufacturing tolerances of the digital imaging device may result in orientation differences between the two imaging sensors. An imaging sensor in one device may be positioned slightly higher than another imaging sensor in the same device. In another device, an imaging sensor may be further forward (closer to the scene being captured) than a second imaging sensor in that device. The imaging sensors may also have different orientations about a rotational axis. For example, differences in pitch, yaw, or roll orientations may exist between the imaging sensors. The images captured by these imaging sensors may reflect these differences. These differences in orientations between the two images of a stereoscopic imaging pair may have undesirable effects. For example, differences in vertical orientation between the two images, known as “vertical disparity,” has been shown to cause headaches in viewers of stereoscopic movies.

To achieve stereoscopic image pairs that are precisely aligned, devices with a plurality of imaging sensors are often calibrated during the manufacturing process. The device may be placed into a special “calibration mode” on the manufacturing line, with the imaging sensors pointed at a target image designed to assist in clearly identifying each sensor's relative position. Each camera of the device may then be focused on the target image and an image captured. Each captured image can then be analyzed to extract the camera's relative orientation.

Some cameras may be designed such that small adjustments to each camera's relative position can be made on the factory floor to better align the positions of the two cameras. For example, each camera may be mounted within an adjustable platform that provides the ability to make small adjustments to its position. Alternatively, the images captured by each camera may be analyzed by image processing software to determine the relative position of each camera to the other. This relative position data is then stored in a non volatile memory on the camera. When the product is later purchased and used, on board image processing utilizes the relative position information to electronically adjust the images captured by each camera to produce high quality stereoscopic images.

These calibration processes have several disadvantages. First, a precise manufacturing calibration consumes time during the manufacturing process, increasing the cost of the device. Second, any calibration data produced during manufacturing is static in nature. As such, it cannot account for changes in camera position as the device is used during its life. For example, the calibration of the multiple lenses may be very precise when the camera is sold, but the camera may be dropped soon after purchase. The shock of the fall may cause the cameras to go out of calibration. Despite this, the user will likely expect the camera to survive the fall and continue to produce high quality stereoscopic images.

Furthermore, expansion and contraction of camera parts with temperature variation may introduce slight changes in the relative position of each camera. Factory calibrations are typically taken at room temperature, with no compensation for variations in lens position with temperature. Therefore, if stereoscopic imaging features are utilized on a particularly cold or hot day, the quality of the stereoscopic image pairs produced by the camera may be affected.

Therefore, a static, factory calibration of a multi camera device has its limits. While a periodic calibration would alleviate some of these issues, it may not be realistic to expect a user to perform periodic stereoscopic camera calibration of their camera during its lifetime. Many users have neither the desire nor often the technical skill to successfully complete a calibration procedure.

### SUMMARY

Some of the present embodiments may include a method of adjusting a stereoscopic image pair. The method may include capturing a first image of the stereoscopic image pair with a first imaging sensor and capturing a second image of the stereoscopic image pair with a second imaging sensor. A set of keypoint matches between the first image and the second image may then be determined. The quality of the keypoint matches is evaluated to determine a keypoint quality level. If the keypoint quality level is greater than a threshold, the stereoscopic image pair may be adjusted based on the keypoints.

One innovative implementation disclosed is a method of calibrating a stereoscopic imaging device. The method includes capturing a first image of a scene of interest with a first image sensor, and capturing a second image of the scene of interest with a second image sensor. The first image and second image may be part of a stereoscopic image pair. The method also includes determining a set of key point matches based on the first image and the second image. The set of keypoint matches form a keypoint constellation. The method further includes evaluating the quality of the keypont constellation to determine a key point constellation quality level, and determining if the key point constellation quality level exceeds a predetermined threshold, wherein if the threshold is exceeded, generating calibration data based on the keypoint constellation and storing the calibration data to a non volatile storage device.

In some implementations, the method also includes determining one or more vertical disparity vectors between keypoints in the one or more keypoint matches in the set of keypoint matches, determining a vertical disparity metric based on the one or more vertical disparity vectors, and comparing the vertical disparity metric to a threshold. if the vertical disparity metric is above the threshold, the method determines keypoint match adjustments based at least in part on the set of keypoint matches.

In some implementations, determining keypoint match adjustments includes determining an affine fit based on the set of keypoint matches, determining a protective fit based on the set of keypoint matches, generating a projection matrix based on the affine fit and the projective fit; and adjusting the set of keypoint matches based on the projection matrix.

In some implementations of the method, the calibration data includes the projection matrix. In some implementations of the method determining an affine fit based on the set of keypoint matches determines a roll estimate, pitch estimate, and scale estimate, and in some other implementations, determining the projective fit determines a yaw estimate. In some implementations, the method also includes adjusting the stereoscopic image pair based on the adjusted set of keypoint matches. In some implementations, the method includes determining new vertical disparity vectors based on the adjusted set of keypoint matches and further adjusting the keypoint matches if the new vertical disparity vectors indicate a disparity above a threshold.

In some implementations, the adjusting of the set of keypoint matches and determining new vertical disparity vectors are iteratively performed until the new vertical disparity vectors indicate a disparity below a threshold. In some implementations, the method is performed in response to the output of an accelerometer exceeding a threshold. In some implementations, the method is performed in response to an autofocus event. In some implementations, the evaluating of the quality of the keypoint constellation includes determining the distance between keypoints.

In some implementations, evaluating the quality of the keypoint constellation comprises determining the distance of each keypoint to an image corner or determining the number of keypoint matches. In some implementations, evaluating of the quality of the keypoint constellation comprises determining a sensitivity of one or more estimates derived from the keypoint constellation to perturbations in the keypoint locations. In some implementations, the method includes pruning the set of keypoint matches based on the location of each keypoint match to remove one or more keypoint matches from the set of keypoint matches.

Another innovative aspect discloses is an imaging apparatus. The imaging apparatus includes a first image sensor, a second imaging sensor, a processor, operatively coupled to the first imaging sensor and the second imaging sensor, a sensor control module, configured to capture a first image of a first stereoscopic image pair from a first image sensor, and to capture a second image of the first stereoscopic image pair from a second image sensor, a keypoint module, configured to determine a set of key point matches between the first image and the second image, a keypoint quality module, configured to evaluate the quality of the set of key point matches to determine a key point constellation quality level, a master control module, configured to compare the keypoint constellation quality level to a predetermined threshold, and if the keypoint constellation quality level is above the predetermined threshold, adjust the stereoscopic image pair based on the keypoint constellation. In some implementations of the apparatus, the keypoint quality module determines the keypoint constellation quality level based, at least in part, on the position of keypoint matches in the keypoint constellation within the first image and the second image. In some other implementations of the apparatus, the keypoint quality module determines the keypoint constellation quality level based, at least in part, on a variation in angle estimates generated based on the keypoint constellation, and on a noisy keypoint constellation based on the keypoint constellation. In some implementations, the noisy keypoint constellation is generated based, at least in part, by adding random noise to at least a portion of keypoint locations for keypoints in the keypoint constellation.

Another innovative aspect disclosed is a stereoscopic imaging device. The device includes means for capturing a first image of a scene of interest with a first image sensor, and means for capturing a second image of the scene of interest with a second image sensor. The first image and second image may be part of a stereoscopic image pair. The device also includes means for determining a set of key point matches based on the first image and the second image, the set of keypoint matches comprising a keypoint constellation, means for evaluating the quality of the keypont constellation to determine a key point constellation quality level, means for determining if the key point constellation quality level exceeds a predetermined threshold, means for generating calibration data based on the keypoint constellation if the threshold is exceeded, and means for storing the calibration data to a non volatile storage device.

Another innovative aspect disclosed is a non-transitory computer readable medium, storing instructions that when executed by a processor, cause the processor to perform the method of capturing a first image of a scene of interest with a first image sensor, capturing a second image of the scene of interest with a second image sensor. The first image and second image comprise a stereoscopic image pair. The method performed by the processor also includes determining a set of key point matches based on the first image and the second image, the set of keypoint matches comprising a keypoint constellation, evaluating the quality of the keypont constellation to determine a key point constellation quality level, and determining if the key point constellation quality level exceeds a predetermined threshold, wherein if the threshold is exceeded, generating calibration data based on the keypoint constellation and storing the calibration data to a non volatile storage device.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 shows an imaging environment including a stereoscopic imaging device that includes two imaging sensors.

FIG. 2A shows the relative position of two imaging sensors about a x, y, and z axis.

FIG. 2B shows the relative position of two imaging sensors when one sensor is rotated about a x axis.

FIG. 2C shows the relative position of two imaging sensors when one sensor is rotated about a y axis.

FIG. 2D shows the relative position of two imaging sensors when one sensor is rotated about a z axis.

FIG. 3 is a block diagram of an imaging device implementing at least one operative embodiment.

FIG. 4 is an example of a stereoscopic image pair including keypoints with misalignments in the y and z axis. A rotational misalignment about the z axis can also be seen.

FIG. 5 is a flowchart of a process for capturing and aligning a stereoscopic image pair if a set of keypoints matches is of sufficient quality.

FIG. 6 is a flowchart of a process for adjusting a stereoscopic image pair.

FIG. 7A is a flowchart illustrating a process for verifying the quality of a keypoint constellation.

FIG. 7B is a flowchart illustrating a process for determining the sensitivity of misalignment estimates for a stereoscopic image pair to random noise in a keypoint constellation.

FIGS. 8A-B show a left image and right image of a stereoscopic image pair.

FIG. 9A shows a keypoint constellation for the images of FIGS. 8A-B.

FIG. 9B illustrates a keypoint constellation after the keypoint constellation has been pruned.

FIG. 10 illustrates an image 1005 composed of both image 805 from FIG. 8A and image 810 from FIG. 8B.

### DETAILED DESCRIPTION

As described above, a relative misalignment between two or more imaging sensors may affect the quality of stereoscopic image pairs produced by an imaging device. In some cases, this misalignment not only results in lower quality stereoscopic images but may also induce physical effects, such as headaches in people who view the images. Reducing or eliminating this misalignment is therefore desirable to ensure high quality stereoscopic image pairs and high customer satisfaction.

One embodiment is a system and method in an electronic device for calibrating pairs of image sensors. The disclosed apparatus and methods may operate continuously and transparently during normal use of the device. Therefore, these methods and apparatus may reduce or eliminate the need for a user to initiate or otherwise facilitate an explicit calibration process. One skilled in the art will recognize that these embodiments may be implemented in hardware, software, firmware, or any combination thereof.

In one implementation, the system may be configured to capture a first image of a target object with a first imaging sensor, and a second image of the target object with a second imaging sensor in order to form a stereoscopic image of the target object. The system can then perform keypoint matching between the first image and the second image to form a keypoint constellation. Keypoints may be distinctive regions on an image that exhibit particularly unique characteristics. For example, regions that exhibit particular patterns or edges may be identified as keypoints. A keypoint match may include a pair of points, with one point identified in the first image and the second point identified in the second image. Keypoint matches may also include pairs of regions, with one region from the first image and one region from the second image. These points or regions of each image may exhibit a high degree of similarity. The set of keypoint matches identified for a stereoscopic image pair may be referred to as a keypoint constellation.

The quality level of the keypoint constellation is then evaluated by the system or apparatus. If the quality level of the keypoint constellation exceeds a quality threshold, the stereoscopic image pair may then be adjusted based on the keypoint constellation. Calibration data derived from the keypoint constellation may also be stored to a non-volatile storage. Additional stereoscopic image pairs may then be adjusted based on the calibration data. These image pairs may include images with keypoint constellations that do not exceed the quality threshold described above. This method may improve the alignment of stereoscopic image pairs.

As mentioned, before a keypoint constellation is used to adjust a stereoscopic image pair, it is evaluated to determine whether the quality of the keypoint constellation exceeds a quality threshold. If the keypoint constellation's quality exceeds the quality threshold, it may indicate the keypoint constellation is such that an accurate and complete adjustment of the stereoscopic image pair may be determined based on the keypoint matches included in the constellation. Whether a keypoint constellation is of sufficient quality may be determined based on several criteria. For example, the number and location of keypoints included in the constellation may be examined. For example, keypoints closer to the edge of the image may provide more accurate adjustments with respect to a relative roll of an image sensor around a z axis when compared to keypoints closer to the center of the image. When one image sensor is rolled around a z axis relative to another image sensor, the location of keypoints closer to the edge of a first image may experience greater relative displacement than the location of keypoints closer to the center of the image. Similarly, when a first image sensor is misaligned relative to a second image sensor about a y or vertical axis, the location of keypoints closer to the left or right edge of the first image may exhibit greater relative displacement when compared to keypoints closer to the center of the image. Keypoints closer to a top or bottom image edge may experience greater displacement when there are misalignments in roll about a x, or horizontal, axis.

Some implementations may evaluate the quality of the keypoint constellation based on whether it contains sufficient keypoint matches within a minimum proximity to each corner of the image. For example, each keypoint of the constellation may be given four scores that are inversely proportional to the keypoint's distance from each corner of the image. The scores of the keypoints for each respective corner may then be added to produce a corner proximity score. This score may then be evaluated against a quality threshold to determine if the keypoint constellation includes enough keypoint matches within a proximity to each corner of the image. By ensuring an adequate number of keypoints within a proximity to each corner of the image, the keypoint constellation's quality can be evaluated for the constellation's ability to enable accurate and complete adjustment of a stereoscopic image pair.

Some implementations may evaluate the quality of a keypoint constellation based in part on the sensitivity of a projection matrix based on keypoints in the constellation to small perturbations in the keypoint locations. These small perturbations may be generated by adding random noise to estimated keypoint positions. If noise added to the estimated keypoint positions causes only relatively small changes in the projection matrix, then the stability of the projection matrix may be adequate to adjust the stereoscopic images based on the keypoint constellation.

Some implementations may combine the above described criteria to determine whether a keypoint constellation's quality is above a quality threshold for the constellation. For example, one implementation may evaluate the numerocity of keypoints and their proximity to the corners or edges of the images of the stereoscopic image pair, and the sensitivity of a projection matrix derived from the keypoints to small perturbations in the estimated locations of the keypoints, to determine whether a keypoint constellation quality measure is above a quality threshold.

Once it has been determined that the keypoint constellation of a stereoscopic image pair is of sufficient quality, some implementations may determine vertical disparity vectors based on the keypoint matches within the constellation. These vertical disparity vectors may represent vertical displacements of keypoints in a first image when compared to the matching keypoints in a second image.

In some implementations, a vertical disparity metric will be determined based on the vertical disparity vectors. For example, in some implementations, the maximum size of the vertical disparity vectors may be determined. The vertical disparity metric may be set to the maximum size. Some other implementations may average the length or size of the vertical disparity vectors, and set the vertical disparity metric to the average. The vertical disparity metric may then be compared to a vertical disparity threshold. If the vertical disparity metric is below the threshold, it may indicate that the images of the stereoscopic image pair are adequately aligned. The vertical disparity threshold may be equivalent to a percentage of the image height. For example, in some implementations, the vertical disparity threshold is two (2) percent of image height. In other implementations, the vertical disparity threshold will be one (1) percent of image height. If a vertical disparity vector or the average is above a threshold, it may indicate misalignment between the images of the stereoscopic image pair such that adjustment of the stereoscopic image should be performed.

To adjust the stereoscopic image pair, an affine fit between the keypoint matches may be performed. This may approximate roll, pitch, and scale differences between the images of the stereoscopic image pair. A correction based on the affine fit may then be performed on the keypoint matches to correct for the roll, pitch and scale differences. A projective fit may then be performed on the adjusted keypoints to determine any yaw differences that may exist between the images of the stereoscopic image pair. Alternatively, the projective fit may be performed on unadjusted keypoints. Based on the estimated roll. yaw, pitch, and scale values, a projection matrix may be determined. The keypoints may then be adjusted based on the projection matrix. In some cases, the stereoscopic image pair may also be adjusted based on the projection matrix.

After the keypoints have been adjusted, new vertical disparity vectors may be determined for each keypoint match in the adjusted keypoint constellation. A new vertical disparity metric may also be determined as described above. If the vertical disparity metric is below the vertical disparity threshold, the adjustment process may be complete. The projection matrix described above may be stored on a non-volatile storage. The stored projection matrix may be used to adjust additional stereoscopic image pairs captured after the stereoscopic image pair from which the keypoint constellation is derived. For example, each new set of image pairs captured by the imaging device may be adjusted using the projection matrix. This adjustment may ensure that the stereoscopic images are properly aligned for viewing by a user.

If the vertical disparity metric is above the vertical disparity threshold, the projection matrix discussed above, and used to adjust the keypoint locations may not yet provide adequate adjustment of the keypoints, and later the stereoscopic image pair, to ensure a satisfactory viewing experience. Therefore, in some implementations additional adjustments to the keypoint constellation may be performed. For example, a new additional affine fit operation may be performed based on the adjusted keypoints. This affine fit may produce new estimates for roll, pitch, and scale adjustments for the adjusted keypoint constellation. A projective fit may also be performed to generate a yaw estimate. The resulting projection matrix may be used to further adjust the keypoint constellation. This process may repeat until the vertical disparity metric for the adjusted keypoint constellation is below a predetermined quality threshold.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

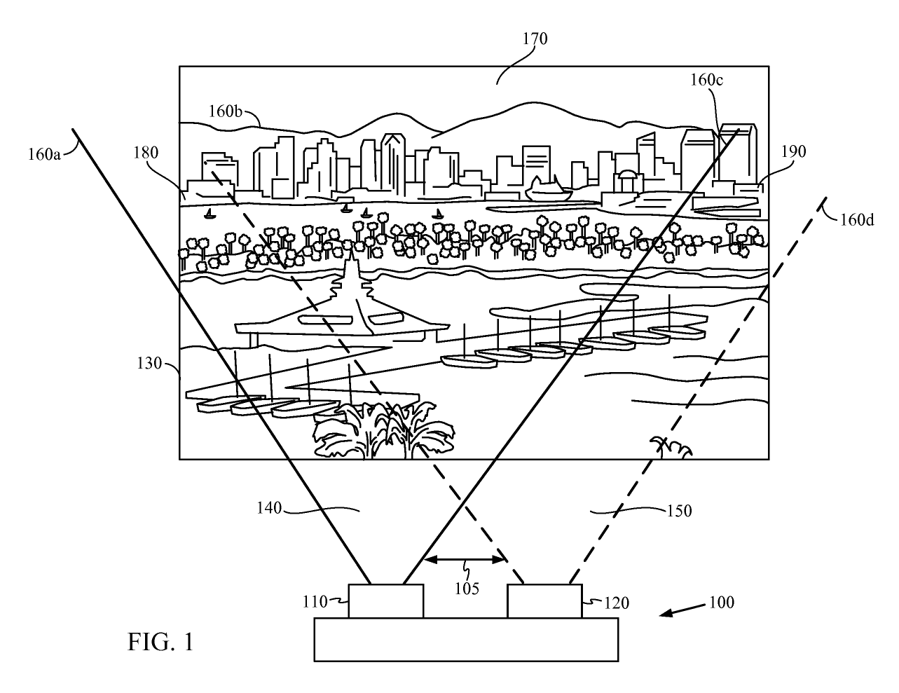

FIG. 1 shows an imaging environment including a stereoscopic imaging device 100 that includes two imaging sensors, 110 and 120. The imaging device 100 is illustrated capturing a scene 130. Each imaging sensor of the camera includes a field of view, indicated by the dark lines 160a-d. The left camera 110 includes a field of view 140 bounded by lines 160a and 160c. The right camera 120 includes a field of view 150, which is bounded by lines 160b and 160d. The fields of view 140 and 150 overlap in area 170. The left camera's field of view 140 includes a portion of the scene not within the field of view of camera 120. This is denoted as area 180. The right camera's field of view 150 includes a portion of the scene not within the field of view of camera 110. This is denoted as area 190. These differences in the field of view of the two cameras 110 and 120 may be exaggerated for purposes of illustration.

The differences in the field of view of each camera 110 and 120 may create parallax between the images. FIG. 1 also shows a horizontal displacement 105 between the two cameras 110 and 120. This horizontal displacement provides the parallax used in a stereoscopic image to create the perception of depth. While this displacement between the two imaging sensors may be an intentional part of the imaging device's design, other unintended displacements or misalignments between the two imaging sensors 110 and 120 may also be present.

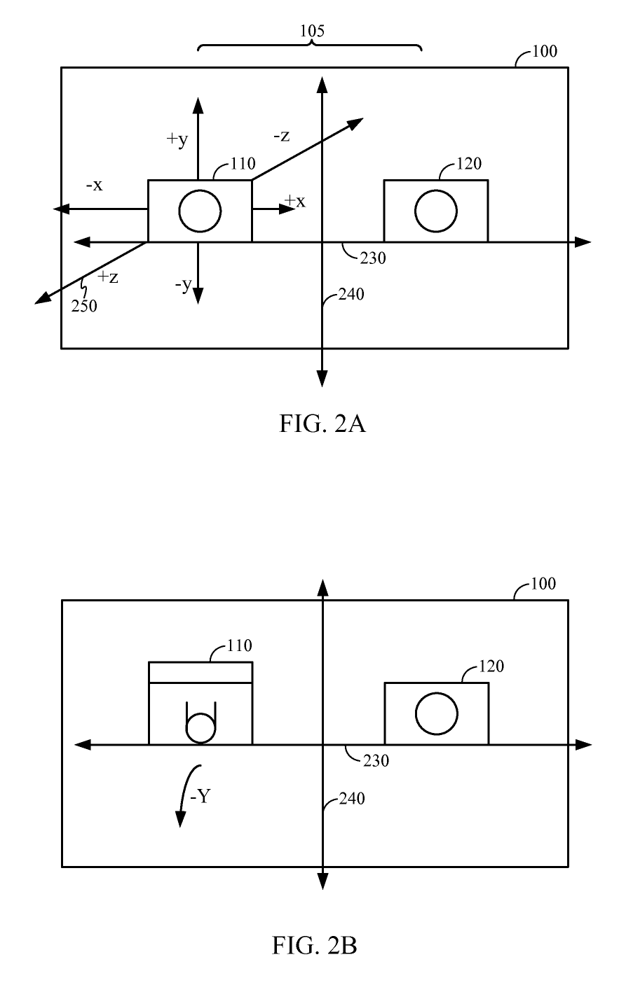

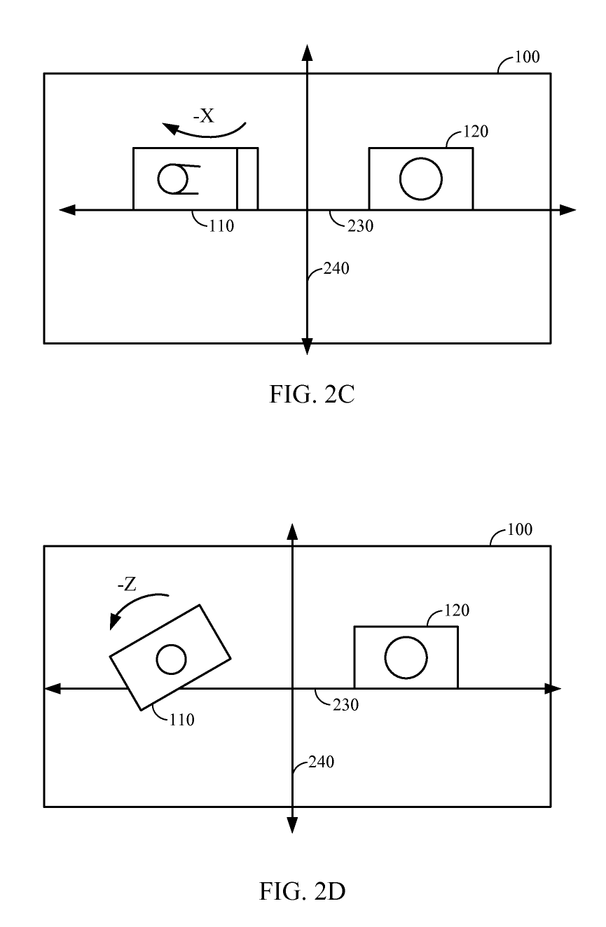

FIG. 2A shows the relative position of two imaging sensors about a x (horizontal), y (vertical), and z (into and out of the figure) axis. The two imaging sensors 110 and 120 are included in an imaging device 100. A predetermined distance 105 between imaging sensor 110 and 120 may be designed into the imaging device 100. As shown, the left imaging sensor 110 may be shifted up or down relative to imaging sensor 120 with reference to the vertical y axis 240. Imaging sensor 110 may also be shifted right or left relative to imaging sensor 120 about the x axis 230. Imaging sensor 110 may also be shifted “into” the figure or “out of the figure relative to the right imaging sensor 120 with reference to a z axis 250. These misalignments between the imaging sensors 110 and 120 may be compensated for by adjustments to a stereoscopic image pair produced by imaging device 100.

FIGS. 2B-D show the relative position of two imaging sensors with imaging sensor 110 rotated about an axis relative to imaging sensor 120. FIG. 2B shows imaging sensor 110 rotated about a horizontal axis, inducing a misalignment in pitch relative to imaging sensor 120. FIG. 2C shows rotation of imaging sensor 110 about a vertical axis, inducing a misalignment in yaw relative to imaging sensor 120. FIG. 2D shows a rotation of imaging sensor 110 about a “z” axis, which extends in and out of the figure. This induces a misalignment in roll relative to imaging sensor 120. The misalignments illustrated in FIGS. 2A-D may be compensated for by adjustments to a stereoscopic image pair produced by imaging device 100.

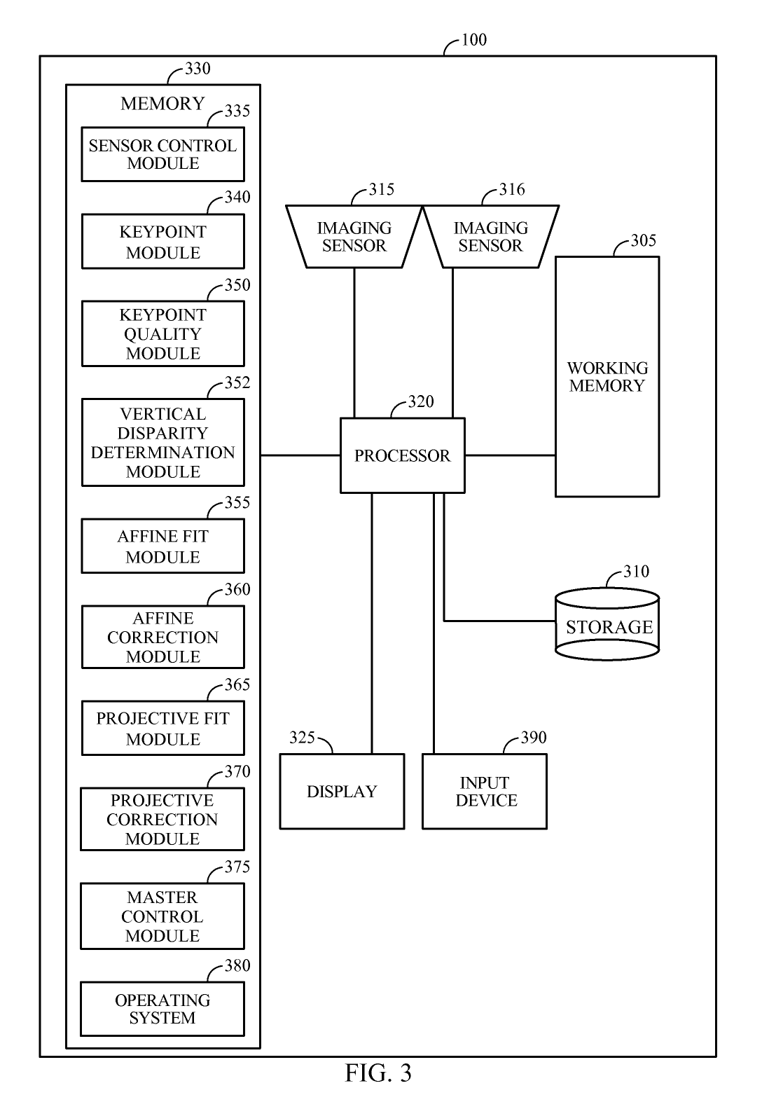

FIG. 3 is a block diagram of an imaging device implementing at least one operative embodiment. The imaging device 100 includes a processor 320 operatively coupled to several components, including a memory 330, a first image sensor 315, a second image sensor 316, a working memory 305, a storage 310, a display 325, and an input device 390.

Imaging device 100 may receive input via the input device 390. For example, input device 390 may be comprised of one or more input keys included in imaging device 100. These keys may control a user interface displayed on the electronic display 325. Alternatively, these keys may have dedicated functions that are not related to a user interface. For example, the input device 390 may include a shutter release key. The imaging device 100 may store images captured into the storage 310. These images may include stereoscopic image pairs captured by the imaging sensors 315 and 316. The working memory 305 may be used by the processor 320 to store dynamic run time data created during normal operation of the imaging device 100.

The memory 330 may be configured to store several software or firmware code modules. These modules contain instructions that configure the processor 320 to perform certain functions as described below. For example, an operating system module 380 includes instructions that configure the processor 320 to manage the hardware and software resources of the device 100. A sensor control module 335 includes instructions that configure the processor 320 to control the imaging sensors 315 and 316. For example, some instructions in the sensor control module 335 may configure the processor 320 to capture an image with imaging sensor 315 or imaging sensor 316. Therefore, instructions in the sensor control module 335 may represent one means for capturing an image with an image sensor. Other instructions in the sensor control module 335 may control settings of the image sensor 315. For example, the shutter speed, aperture, or image sensor sensitivity may be set by instructions in the sensor control module 335.

A keypoint module 340 includes instructions that configure the processor 320 to identify keypoints within images captured by the first imaging sensor 315 and the second image sensor 316. As mentioned earlier, in one embodiment, keypoints are distinctive regions on an image that exhibit particularly unique characteristics. For example, regions that exhibit particular patterns or edges may be identified as keypoints. Keypoint module 340 may first analyze a first image captured by the imaging sensor 315 of a target scene and identify keypoints of the scene within the first image. The keypoint module 340 may then analyze a second image captured by imaging sensor 316 of the same target scene and identify keypoints of the scene within that second image. Keypoint module 340 may then compare the keypoints found in the first image and the keypoints found in the second image in order to identify keypoint matches between the first image and the second image. A keypoint match may include a pair of points, with one point identified in the first image and the second point identified in the second image. The points may be a single pixel or a group of 2, 4, 8, 16 or more neighboring pixels in the image. Keypoint matches may also include pairs of regions, with one region from the first image and one region from the second image. These points or regions of each image may exhibit a high degree of similarity. The set of keypoint matches identified for a stereoscopic image pair may be referred to as a keypoint constellation. Therefore, instructions in the keypoint module may represent one means for determining key point matches between a first image and a second image of a stereoscopic image pair.

A keypoint quality module 350 may include instructions that configure processor 320 to evaluate the quality of a keypoint constellation determined by the keypoint module 340. For example, instructions in the keypoint quality module may evaluate the numerosity or relative position of keypoint matches in the keypoint constellation. The quality of the keypoint constellation may be comprised of multiple scores, or it may be a weighted sum or weighted average of several scores. For example, the keypoint constellation may be scored based on the number of keypoint matches within a first threshold distance from the edge of the images. Similarly, the keypoint constellation may also receive a score based on the number of keypoint matches. The keypoint constellation may also be evaluated based on the proximity of each keypoint to a corner of the image. As described earlier, each keypoint may be assigned one or more corner proximity scores. The scores may be inversely proportional to the keypoint's distance from a corner of the image. The corner proximity scores for each corner may then be added to determine one or more corner proximity scores for the keypoint constellation. These proximity scores may be compared to a keypoint corner proximity quality threshold when determining whether the keypoint constellation's quality is above a quality threshold.

The sensitivity of the projective fit derived from the keypoints may also be evaluated to at least partially determine an overall keypoint constellation quality score. For example, a first affine fit and a first projective fit may be obtained using the keypoint constellation. This may produce a first set of angle estimates for the keypoint constellation. Next, random noise may be added to the keypoint locations. After the keypoint locations have been altered by the addition of the random noise, a second affine fit and a second projective fit may then be performed based on the noisy keypoint constellation.

Next, a set of test points may be determined. The test points may be adjusted based on the first set of angle estimates and also adjusted based on the second set of angle estimates. The differences in the positions of each test point between the first and second set of angle estimates may then be determined. An absolute value of the differences in the test point locations may then be compared to a projective fit sensitivity threshold. If the differences in test point locations are above the projective fit sensitivity threshold, the keypoint constellation quality level may be insufficient to be used in performing adjustments to the keypoint constellation and the stereoscopic image pair. If the sensitivity is below the threshold, this may indicate that the keypoint constellation is of a sufficient quality to be used as a basis for adjustments to the stereoscopic image pair.

The scores described above may be combined to determine a keypoint quality level. For example, a weighted sum or weighted average of the scores described above may be performed. This combined keypoint quality level may then be compared to a keypoint quality threshold. If the keypoint quality level is above the threshold, the keypoint constellation may be used to determine misalignments between the images of the stereoscopic image pair.

A vertical disparity determination module 352 may include instructions that configure processor 320 to determine vertical disparity vectors between a stereoscopic image pair's matching keypoints in a keypoint constellation. The keypoint constellation may have been determined by the keypoint module 340. The size of the vertical disparity vectors may represent the degree of any misalignment between the imaging sensors utilized to capture the images of the stereoscopic image pair. Therefore, instructions in the vertical disparity determination module may represent one means for determining the vertical disparity between keypoint matches.

An affine fit module 355 includes instructions that configure the processor 320 to perform an affine fit on a stereoscopic image pair's keypoint match constellation. The affine fit module 355 may receive as input the keypoint locations in each of the images of the stereoscopic image pair. By performing an affine fit on the keypoint constellation, the affine fit module may generate an estimation of the vertical disparity between the two images. The vertical disparity estimate may be used to approximate an error in pitch between the two images. The affine fit performed by the affine fit module may also be used to estimate misalignments in roll, pitch, and scale between the keypoints in a first image of a stereoscopic image pair and the keypoints of a second image of the stereoscopic image pair.

An affine correction module 360 may include instructions that configure the processor 320 to adjust keypoint locations based on the affine fit produced by the affine fit module 355. By adjusting the location of keypoints within an image, the affine correction module may correct misalignments in roll, pitch, or scale between the two set of keypoints from a stereoscopic image pair.

A projective fit module 365 includes instructions that configure the processor 320 to generate a projection matrix based on the keypoint constellation of a stereoscopic image pair. The projective fit may also produce a yaw angle adjustment estimate. The projection matrix produced by the projective fit module 365 may be used to adjust the locations of a set of keypoints in one image of a stereoscopic image pair based on locations of a second set of keypoints in another image of the stereoscopic image pair. To generate the projection matrix, the projective fit module 365 receives as input the keypoint constellation of the stereoscopic image pair. A projective correction module 370 includes instructions that configure the processor 320 to perform a projective correction on a keypoint constellation or on one or both images of a stereoscopic image pair based on the projection matrix.

A master control module 375 includes instructions to control the overall functions of imaging device 100. For example, master control module 375 may invoke subroutines in sensor control module 335 to capture a stereoscopic image pair by first capturing a first image using imaging sensor 315 and then capturing a second image using imaging sensor 316. Master control module may then invoke subroutines in the keypoint module 340 to identify keypoint matches within the images of the stereoscopic image pair. The keypoint module 340 may produce a keypoint constellation that includes keypoints matches between the first image and the second image. The master control module 375 may then invoke subroutines in the keypoint quality module to evaluate the quality of the keypoint constellation identified by the keypoint module 340. If the quality of the keypoint constellation is above a threshold, master control module may then invoke subroutines in the vertical disparity determination module to determine vertical disparity vectors between matching keypoints in the keypoint constellation determined by keypoint module 340. If the amount of vertical disparity indicates a need for adjustment of the stereoscopic image pair, the master control module may invoke subroutines in the affine fit module 355, affine correction module 360, projective fit module 365, and the projective correction module 370 in order to adjust the keypoint constellation. The stereoscopic image pair may also be adjusted.

The master control module 375 may also store calibration data such as a projection matrix generated by the projective fit module 365 in a stable non-volatile storage such as storage 310. This calibration data may be used to adjust additional stereoscopic image pairs.

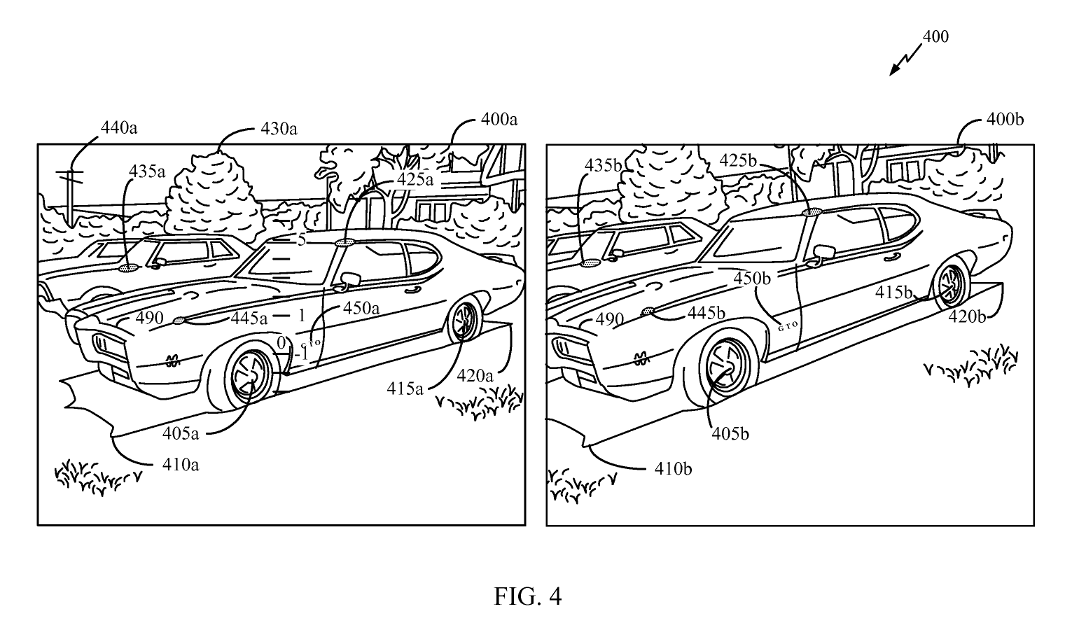

FIG. 4 is an example of a stereoscopic image 400 including keypoints with misalignments in the y and z axis. A rotational misalignment about the z axis can also be seen. The stereoscopic image 400 includes two images 400a and 400b. An exaggerated misalignment between the left image 400a and right image 400b is illustrated for purposes of this disclosure. Relative to left image 400a, right image 400b represents a perspective that is somewhat closer to the car than the perspective of image 400a. The imaging sensor that captured image 400b may be positioned closer to the car 490 than the imaging sensor that captured image 400a.

The imaging sensor that captured image 400b also had a rotation about a z axis relative to the imaging sensor that captured image 400a. As a result, keypoints on the left side of image 400a appear higher in the image than the matching keypoints of image 400b. For example, the reflections 435a and 445a are higher in image 400a than reflections 435b and 445b are in image 400b. Keypoints on the right side of image 400a are lower than the matching keypoints of image 400b. For example, the edge of the shadow keypoint 420a, is lower in the image than its matching keypoint 420b in image 400b. Similarly, the center of the rear rally II wheel, keypoint 415a is higher in image 400a than the matching keypoint 415b is in image 400b. The relative location of the matching keypoints of image 400a and 400b may be used by the methods and apparatus disclosed to adjust stereoscopic image pair 400.

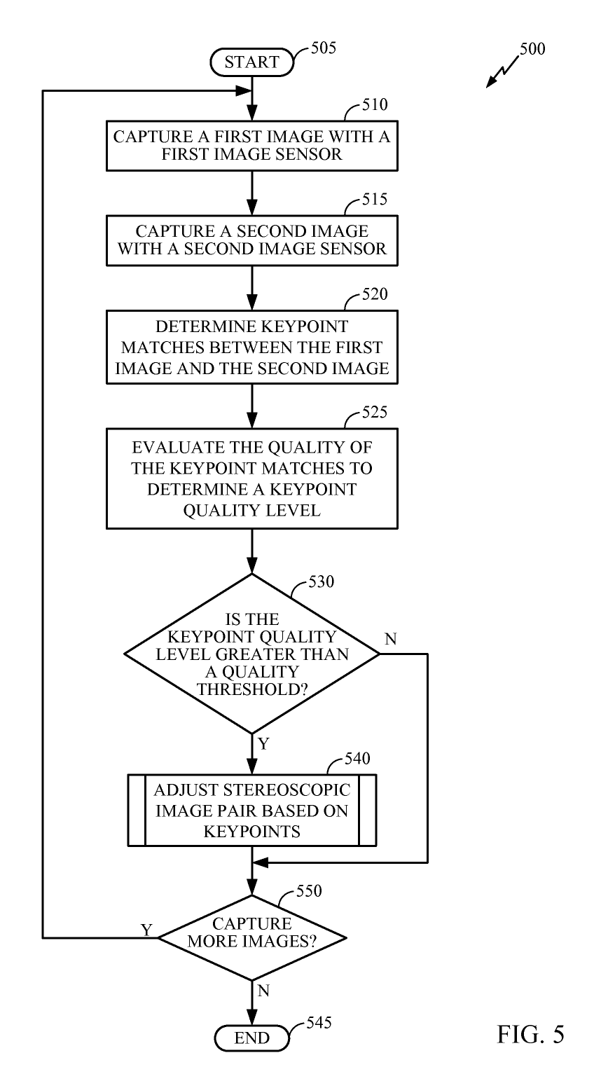

FIG. 5 is a flowchart of a process 500 for capturing and aligning a stereoscopic image pair if a set of keypoint matches is of sufficient quality. The process 500 may be implemented in the memory 330 of device 100, illustrated in FIG. 3. Process 500 begins at start block 505 and then moves to block 510 where a first image is captured with a first imaging sensor. Process 500 then moves to block 515 where a second image is captured with a second imaging sensor. As can be appreciated, capture of the first image and the second image may occur substantially simultaneously in order to properly record a stereoscopic image of a scene of interest. Processing blocks 510 and 515 may be implemented by instructions included in the sensor control module 335, illustrated in FIG. 3.

The process 500 then moves to block 520, where a keypoint constellation is determined. The keypoint constellation may include matching keypoints between the first image and the second image. Processing block 520 may be implemented by instructions included in the keypoint module 340, illustrated in FIG. 3. Process 500 then moves to block 525, where the quality of the keypoint constellation is evaluated to determine a keypoint constellation quality level. Processing block 525 may be performed by instructions included in the keypoint quality module 350, illustrated in FIG. 3. The process 500 then moves to decision block 530, where the keypoint constellation quality level is compared to a quality threshold. If the keypoint constellation quality level is below the threshold, process 500 moves to decision block 550.

If the keypoint quality level is greater than a threshold, the process 500 moves to processing block 540, where the stereoscopic image pair including the first image and the second image is adjusted based on the keypoints. Process 500 then moves to decision block 550 where it is determined if more images should be captured. For example, in some implementations, the process 500 may operate continuously in order to maintain current calibration of a stereoscopic imaging device. In these implementations for example, the process 500 may return to the processing block 510 from decision block 550, where the process 500 would repeat. In some other implementations, the process 500 may transition to end block 545.

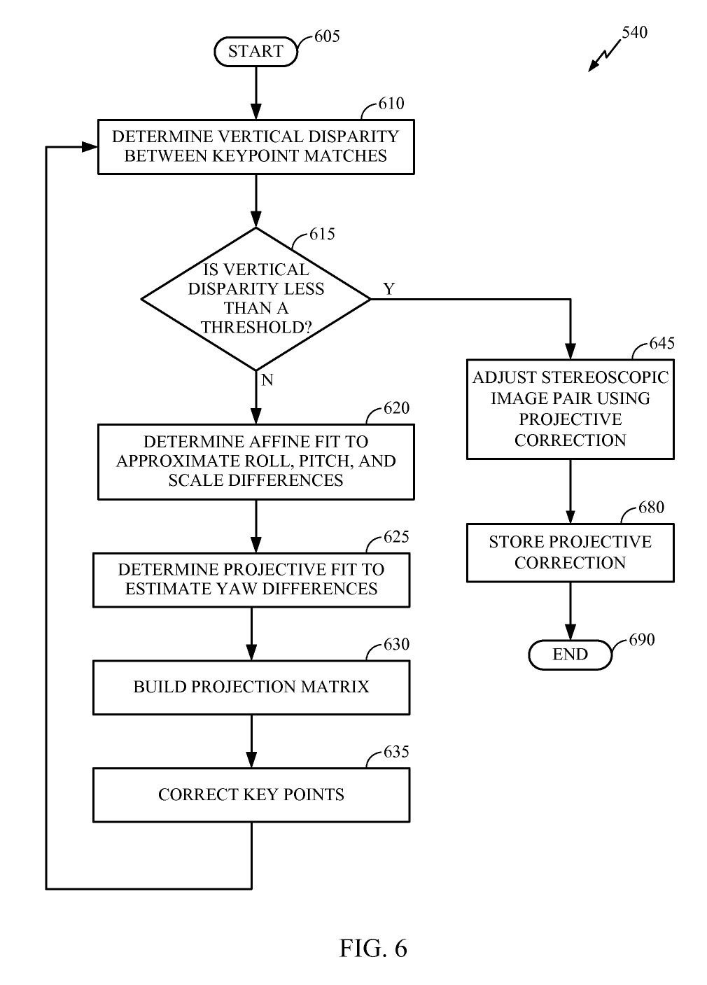

FIG. 6 is a flowchart of the process 540 from FIG. 5 for adjusting a stereoscopic image pair. Process 540 may be implemented by modules included in memory 330 of the device 100, illustrated in FIG. 3. The process 540 begins at start block 605 and then moves to processing block 610, where the vertical disparity between keypoint matches is determined. The processing block 610 may be implemented by instructions included in the vertical disparity determination module 352, illustrated in FIG. 3. In some implementations, a vertical disparity vector may be determined for each keypoint match. The vertical disparity vector may indicate how the vertical position of a keypoint in a first image of the stereoscopic image pair corresponds to a vertical position of a matching keypoint in a second image of the stereoscopic image pair.

After the vertical disparities of each keypoint match have been determined, the process 540 moves to decision block 615. Decision block 615 determines if the vertical disparity between the two images of the stereoscopic image pair is less than a threshold. In some implementations, the size of each vertical disparity vector generated in block 610 may be compared to a threshold. If any vector size is above the threshold, process 540 may consider that the vertical disparity is not less than the threshold, and process 540 may move to block 680. Other implementations may average the length of all the vertical disparity vectors generated in processing block 610. The average may then be compared to a vertical disparity threshold. In these implementations, if the average vertical disparity is not less than the threshold, the process 540 may consider that the vertical disparity is not less than a threshold, and the process 540 moves to processing block 620.

Processing block 620 may be performed by instructions included in the affine fit module 355, illustrated in FIG. 3. In processing block 620, an affine fit of the keypoint matches is determined to approximate roll, pitch, and scale differences between the first and second image of the stereoscopic image pair. The process 540 then moves to processing block 625, where a yaw estimate is determined based on the projective fit of the keypoints. Block 625 may be performed by instructions included in the projective fit module 365, illustrated in FIG. 3.

Process 540 then moves to block 630, where a projection matrix is built. In some implementations, processing block 630 receives as input the estimated angle and scale corrections generated by the affine transforms produced in block 620 and the yaw estimate produced by the projective fit performed in block 625. Block 630 may produce a projection matrix that maps coordinates of data in one image of the stereoscopic image pair to coordinates of corresponding data in the second image of a stereoscopic image pair.

Process 540 then moves to block 635, where the keypoints of the stereoscopic image pair are adjusted using the projection matrix Process 540 then returns to block 610 and process 540 repeats.

If at decision block 615, the vertical disparity is determined to be less than a threshold, the keypoints of the stereoscopic image pair may be sufficiently aligned. Process 540 then moves to block 645, where the stereoscopic image pair is adjusted using the projection matrix built in block 630. Process 540 then moves to block 680, where the matrix for the projective correction is stored. In some implementations, the matrix may be stored in a non-volatile memory. For example, it may be stored in the storage 310 of device 100, illustrated in FIG. 3. After processing of the stereoscopic image and storing of the projection matrix is completed, process 540 then moves to end block 690.

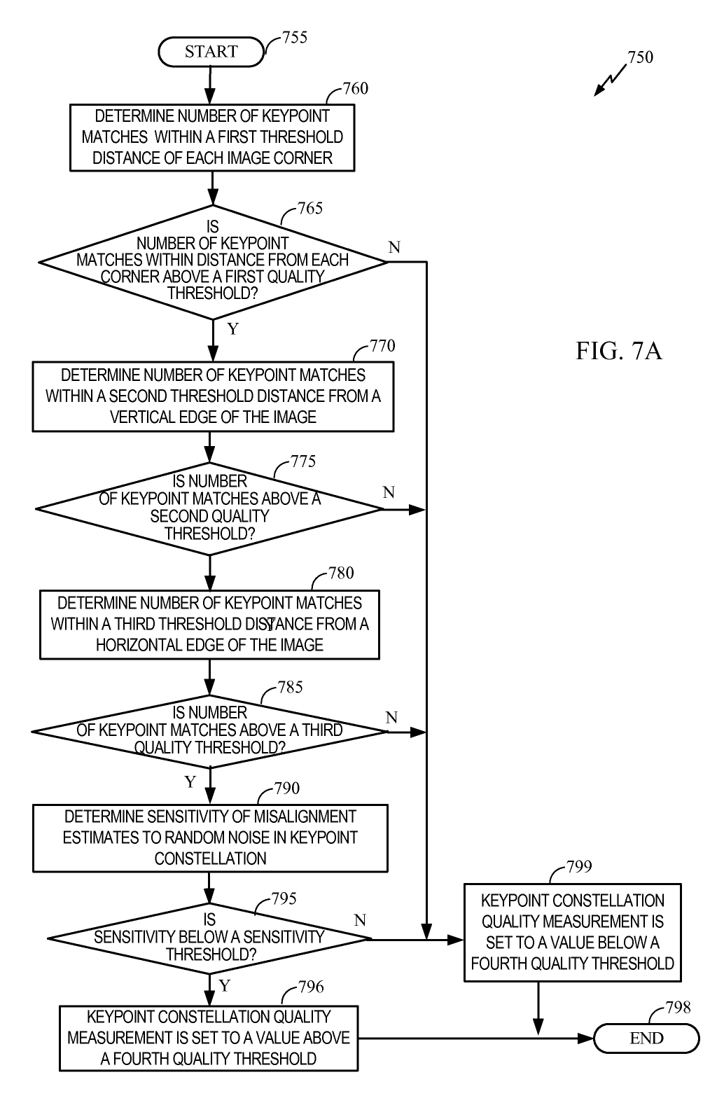

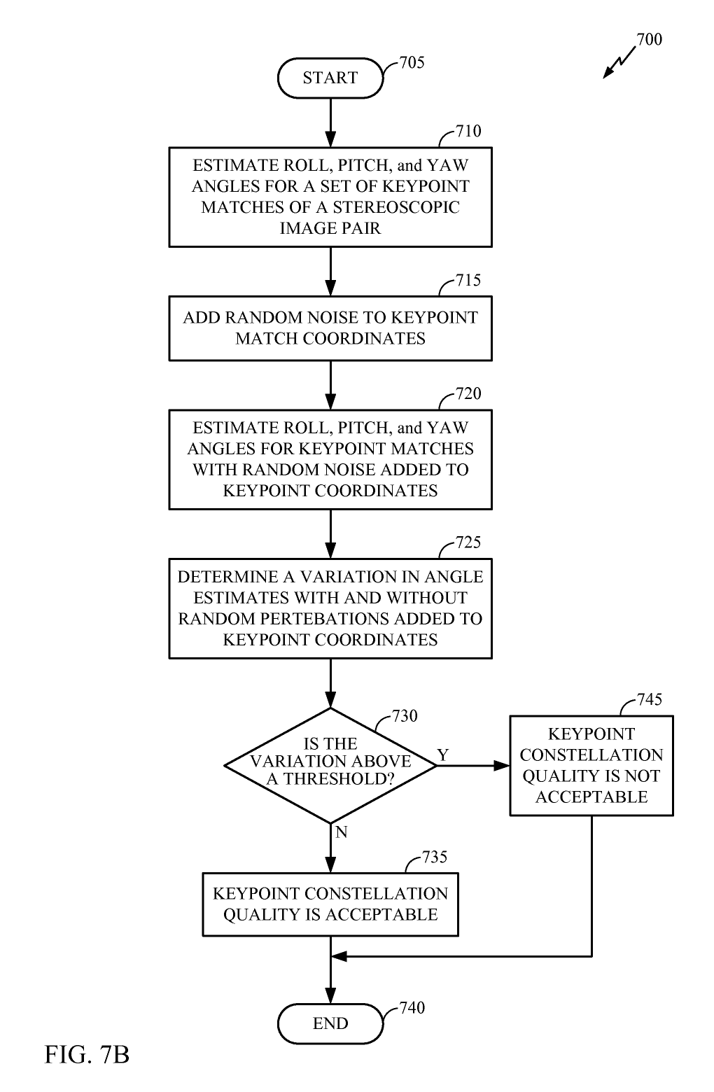

FIG. 7A is a flowchart illustrating one implementation of a process for verifying the quality of a keypoint constellation. Process 750 may be implemented by instructions included in the keypoint quality module 350, illustrated in FIG. 3. Process 750 begins at start block 755 and then moves to block 760 where a number of keypoint matches within a first threshold distance of each image corner is determined. Process 750 then moves to decision block 765, where the number of keypoints for each corner determined in block 760 is compared to a first quality threshold. If the number of keypoints for each corner is below the first quality threshold, process 750 moves to block 796, discussed below. If the number of keypoints for each corner is above the first quality threshold, process 750 moves to block 770, which determines the number of keypoint matches within a second threshold distance from the vertical edges of the image. Process 750 then moves to block 775, which determines if the number of keypoints determined in block 770 is above a second quality threshold. If the number of keypoints determined in block 770 is below the second quality threshold, process 750 moves to block 799, discussed below. If the number of keypoints is above the second quality threshold, process 750 moves to block 780. In block 780, the number of keypoint matches within a third threshold distance from a horizontal edge of the image is determined. Process 750 then moves to block 785, which determines if the number of keypoint matches determined in block 780 is above a third quality threshold. If it is, process 750 moves to block 790.

In block 790, process 750 determines a sensitivity measurement for estimates in misalignment between the two images of the stereoscopic image pair. For example, in some implementations, estimates of pitch, roll, scale, or yaw errors between two images of a stereoscopic image pair may be determined. These estimates may be based, at least in part, on the keypoint constellation. When random noise is added to the locations of at least a portion of keypoints included in the keypoint constellation, these estimates in roll, pitch, yaw, or scale may change. Block 790 determines a measurement for this change in angle measurement when random noise is added to portions of the keypoint constellation. After a measurement of the sensitivity is determined, process 750 moves to block 795, where the sensitivity measurement is compared to a sensitivity threshold. If the sensitivity measurement is above the sensitivity threshold, use of the keypoint constellation for image alignment could be unreliable. In that case, process 750 moves to block 799, where a keypoint constellation quality measurement is set to a value below a fourth quality threshold.

In decision block 795, if the sensitivity measurement determined in block 790 is below the sensitivity threshold, process 750 moves to block 796, where a keypoint quality measurement is set to a value above the fourth quality threshold. Process 750 then moves to end block 798.

FIG. 7B is a flowchart illustrating a process for determining the sensitivity of misalignment estimates for a stereoscopic image pair to random noise in a keypoint constellation. The process then sets the quality level of the keypoint constellation based on the sensitivity. Process 700 may be implemented by instructions included in the keypoint quality module 350, illustrated in FIG. 3. Process 700 begins at start block 705 and then moves to processing block 710 where estimates for roll, pitch and yaw angles are generated for a set of keypoint matches in a stereoscopic image pair. The roll, pitch, and yaw angle estimates may be generated, in some implementations, using the process described in FIG. 6. For example, processing blocks 620, 625, 630, and 635 may be included in processing block 710. Block 715 adds random noise to the keypoint matches of the stereoscopic image pair. Block 720 estimates roll, pitch, and yaw angles for keypoint matches including random noise. As with block 710, the estimation of roll, pitch, and yaw may be performed as described in FIG. 6. In block 725, a variation between the angle estimates generated in block 710 and the estimates generated in block 720 is determined. In some implementations, the difference between each the angle estimate for each keypoint match are added together to determine the variation. In other implementations, the differences between angle estimates of each keypoint may be averaged to determine the variation. In some other implementations, the maximum difference in an angle estimate may be identified. Some other implementations may determine a statistical variance or standard deviation between the differences in the angle estimates. The determination of the variation may be based on the variance or standard deviation in some implementation

In block 730, the variance determined in block 725 is compared to a threshold. If the variance is above the threshold, process 700 moves to block 745, where the quality of the keypoint constellation is determined to be not acceptable for adjusting a stereoscopic image pair. If the variance is below a threshold, process 700 moves to block 740, where the keypoint constellation quality level is determined to be acceptable for use in adjusting a stereoscopic image pair. Process 700 then moves to end block 740.

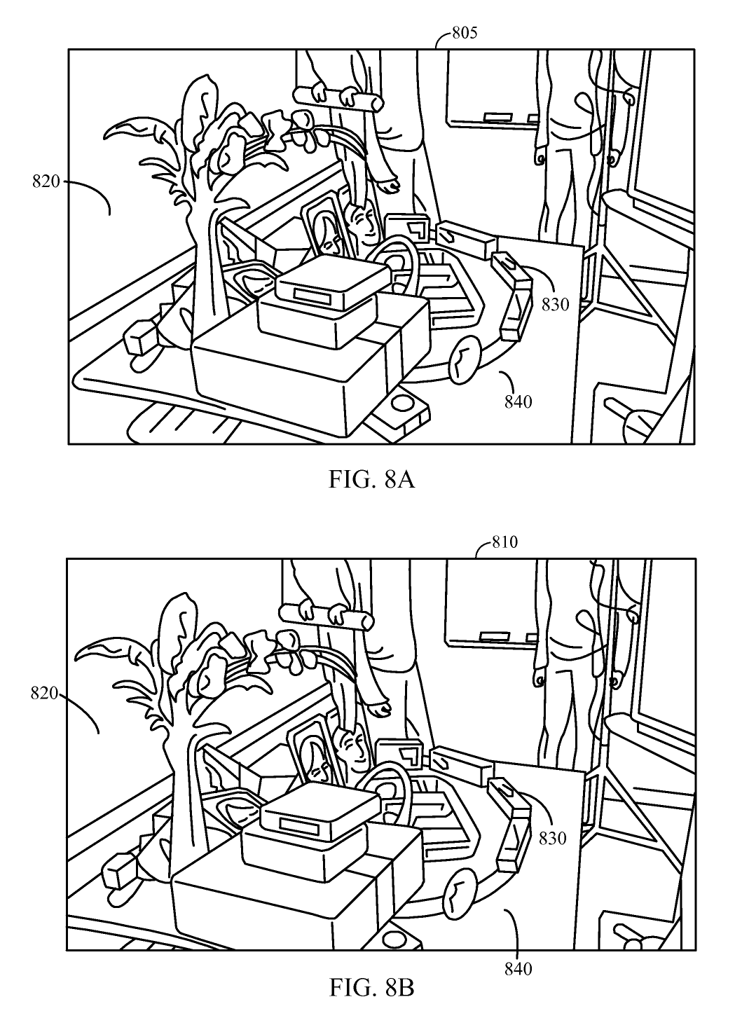

FIGS. 8A-B show a left image 805 and right image 810 of a stereoscopic image pair. Using the methods disclosed, the alignment of images 805 and 810 may be improved. As discussed previously, the keypoint matches between image 805 and image 810 may be determined.

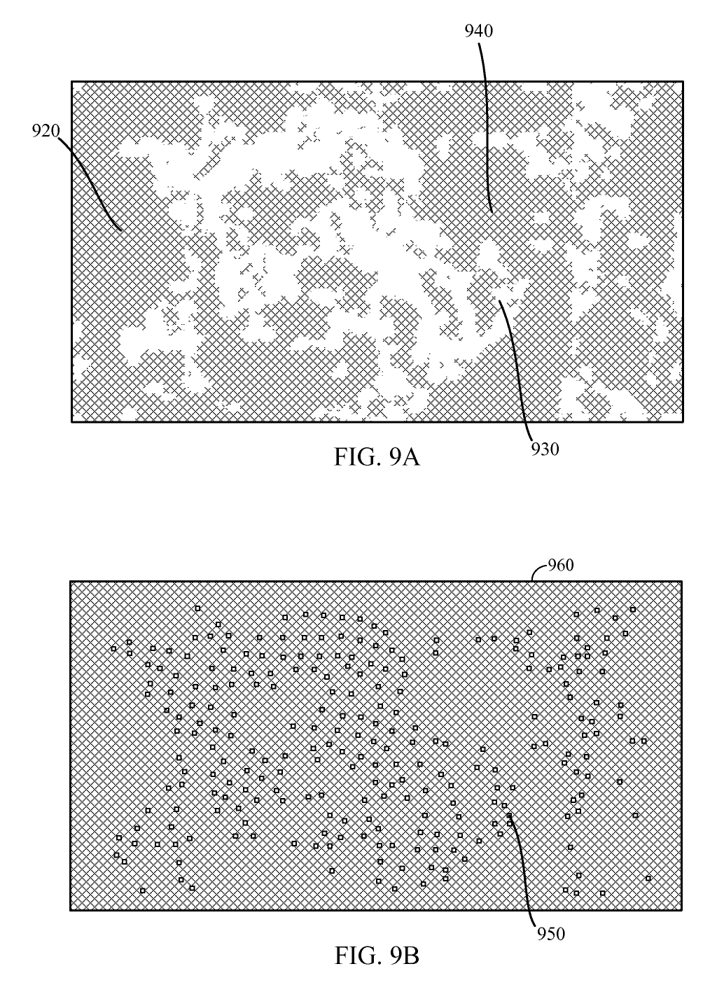

FIG. 9A shows a keypoint constellation for the images of FIGS. 8A-B. In FIG. 9A, white is used to represent a location of a keypoint match, while black is used to represent the lack of a keypoint match in that location. For example, dark/black region 940 may correspond to at least a portion of the table 840 in original images 805 and 810. Because the table is relatively featureless and of a consistent color, the area of the table in the images does not provide keypoint matches between the images. Similarly, dark/black region 920 may correspond to the white board 820 of the original images 805 and 810 for similar reasons. White region 930 of the keypoint map may correspond to the train on the table 830 in original images 805 and 810. Because the train contrasts with the table, it may provide keypoints between the images.

After the initial set of keypoints is established, some implementations may reduce or “prune” the number of keypoints based on a set of criteria. For example, if some keypoint matches are within a threshold distance of each other, some implementations may delete one or more of the keypoint matches to reduce redundancy within the keypoint constellation and provide for more efficient processing. One result of such a pruning process can be observed in FIG. 9B.

FIG. 9B illustrates a keypoint constellation 960 after the keypoint constellation has been pruned. Note that a portion of the keypoints 950 corresponding to the train 830 remain, among others. Once the keypoint constellation has been pruned, vertical disparity vectors between corresponding keypoints are calculated. This may be performed, for example, by processing block 610 in FIG. 6.

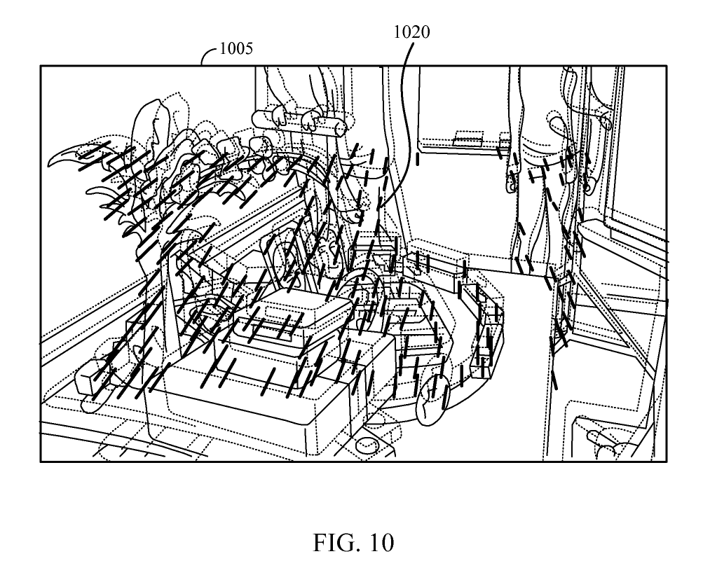

FIG. 10 illustrates an image 1005 composed of both image 805 from FIG. 8A and image 810 from FIG. 8B. Image 1005 also includes vertical disparity vectors 1020 between selected keypoints from a keypoint constellation. If the vertical disparity indicated by the vertical disparity vectors is above a threshold, adjustments to the images may be performed to better align them. To determine if the vertical disparity is above a threshold, a vertical disparity metric may be determined as described earlier. The vertical disparity metric is then compared to a threshold. If the vertical disparity metric is above a threshold, the images may be adjusted based on the keypoint constellation.

To adjust the stereoscopic image pair, adjustments may be determined based on the keypoint constellation of the two images 805 and 810. One implementation may first determine the focal distance in pixels. Portions of the Matlab® code used to perform the adjustments to the keypoint constellation and the stereoscopic image pair in one implementation are provided below. The Matlab® code references several variables. Their definition in the given implementation will first be provided.
hFOV is the horizontal field of view (in degrees) of each image of the stereoscopic image pair.
image_width is the image width in pixels of one image of the stereoscopic image pair.
image_height is the image height in pixels of one image of the stereoscopic image pair.
Vector dv is a N×4 dimensional vector, with N being the number of keypoint matches. The column dimensions of the vector are defined as follows:
   The first column is a x coordinate of a keypoint in a first image
   The second column is a y coordinate of a keypoint in the first image
   The third column is a x coordinate of a keypoint in a second image
   The fourth column is a y coordinate of a keypoint in the second image;

The following Matlab® code segment may be used in some implementations to determine the focal distance of the images:

Code Segment 1:

focal_distance=Image Width/2/tan(hFOV/2/180*pi)

Next, an affine transform may be performed to estimate the vertical rotation (pitch), roll rotation (around a z axis), and scale differences between the two images. The Matlab® code to perform the affine transform is as follows:

Code Segment 2:

in=[dv(:,1:2)dv(:,1)./dv(:,1)];
in=in′;
in(1,:)=in(1,:)−image_height/2;
in(2,:)=in(2,:)−image_width/2;
out=[dv(:,1)+dv(:,3)];
out=out−image_height/2;
out=out′;
r=out*pinv(in);
outn=r*in;
outd=in(1,:)+outn−out;
scale =sqrt(r(1)\hat{ }2+r(2)\hat{ }2);
r=r/z;
roll =−atan(r(3)/focal_distance)/pi*180;
pitch=asin(r(2))/pi*180

Next, a projective transform may be performed to obtain an estimate for the horizontal rotation or yaw, as shown in code segment 3 below:

Code Segment 3:

outd = outd/focal_distance
in=in/focal_distance;
yaw = ((in(1, :)−outd)*pinv(in(2, :). *outd))/pi*180;

Before a keypoint constellation is used to adjust a stereoscopic image pair, the quality of the keypoint constellation may be evaluated to determine if it exceeds a threshold. In some implementations, the keypoint constellation quality is determined based on whether the addition of random perturbations to the keypoint coordinates changes the estimate of roll, pitch, and yaw angle estimates derived from the keypoints by more than a threshold level. Some implementations may utilize a process similar to process 700, illustrated in FIG. 7B, to verify the quality of the keypoint constellation.

In some implementations, once the angle estimates are determined and the quality of the keypoint constellation verified, the keypoint locations are adjusted based on the angles. In some implementations, the keypoint locations in a first image maintain their original coordinates, and the keypoints in a second image are adjusted to better align with the first image. In other implementations, the keypoint locations in both images are adjusted. For example, these implementations may adjust the keypoints in each image based on angle estimates equivalent to one half the angle estimates calculated above. Adjustments based on scale can be performed by using the determined scale estimate as a multiplicative factor on the keypoints. For example, equation 2 below may be used to adjust a keypoint based on the scale estimate:

Code Segment 4:

new_keypoint_coordinate=old_keypoint_coordinate*scale.

Alternatively, some implementations may adjust both sets of keypoints based on the scale estimate. For example, in those implementations, code segment 5 may be utilized.

Code Segment 5:

new_keypoint_coordinate_in_first image =
old_keypoint_coordinate_in first_image * scale/2.
new_keypoint_coordinate_in_second_image =
old_keypoint_coordinate_in second_image * −scale/2.

To adjust the keypoints based on the angle estimates for yaw, pitch, and roll, in one implementation, a projection matrix is created based on the yaw, pitch, and roll angle estimates. Matlab® code to construct the matrix R is shown below in code segment 6:

Code Segment 6:

function R = get_matrix(roll, yaw, pitch)
% Get matrix from rotation angles
Ra=[1 0 0 ;0 cos(roll) −sin(a);0 sin(roll) cos(roll)];
Rb=[cos(yaw) 0 sin(yaw); 0 1 0 ; −sin(yaw) 0 cos(yaw)];
Rc=[cos(pitch) −sin(pitch) 0; sin(pitch) cos(pitch) 0; 0 0 1];
R=Ra*Rb*Rc;
end

Once the projection matrix R has been constructed, the keypoints may be adjusted in some implementations with the Matlab® code provided below.

Code Segment 7:

function dv_new =
proj_with_kp(dv,R,hFOV,image_width,image_height)
hFOV=hFOV/180*pi;
D=image_width/2/tan(hFOV/2);
x=image_height;
y=image_width;
p=ones(3,3);
p(1:2,3)=p(1:2,3)*D;
p(3,1:2)=p(3,1:2)/D;
R=p.*R;
dv_new=dv;
for kk=1:length(dv)

i=dv(kk,1);
j=dv(kk,2);
% projective transform
ln=R*[j−y/2;i−x/2;1];%j,y: cols
jn=ln(1)/ln(3)+y/2;
in=ln(2)/ln(3)+x/2;
dv_new(kk,3)=in−i;
dv_new(kk,4)=jn−j;

end

end

After the keypoints have been adjusted, new vertical disparity vectors may be calculated. A vertical disparity metric may be determined based on the vertical disparity vectors as discussed previously. The vertical disparity metric may be compared to a threshold in some implementations, for example, as illustrated by decision block 615 in FIG. 6. If the metric is below a threshold, the entire image may then be adjusted based on the transform above. Some other implementations may adjust the stereoscopic image pair with every iteration. The projective correction resulting from the process described above may be stored, and used to correct additional stereoscopic image pairs captured after the projection matrix is created.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as a Pentium® processor, a Pentium® Pro processor, a 8051 processor, a MIPS® processor, a Power PC® processor, or an Alpha® processor. In addition, the processor may be any conventional special purpose processor such as a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as Linux®, UNIX® or Microsoft Windows®.

The system may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code. The system may also be written using interpreted languages such as Perl, Python or Ruby.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media include both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone,

B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

We claim:

1. A method of calibrating a stereoscopic imaging device, comprising:
capturing a first image of a scene of interest with a first image sensor;
capturing a second image of the scene of interest with a second image sensor, wherein the first image and second image comprise a stereoscopic image pair;
determining a set of keypoint matches based on the first image and the second image, the set of keypoint matches comprising a keypoint constellation;
evaluating the quality of the keypoint constellation to determine a keypoint constellation quality level; and
determining if the keypoint constellation quality level exceeds a predetermined threshold, wherein if the threshold is exceeded, generating calibration data based on the keypoint constellation and storing the calibration data to a non volatile storage device.

2. The method of claim 1, wherein generating calibration data based on the keypoint constellation comprises:
determining one or more vertical disparity vectors between keypoints in the one or more keypoint matches in the set of keypoint matches;
determining a vertical disparity metric based on the one or more vertical disparity vectors;
comparing the vertical disparity metric to a threshold; and
if the vertical disparity metric is above the threshold, determining keypoint match adjustments based at least in part on the set of keypoint matches.

3. The method of claim 2, wherein determining keypoint match adjustments comprises:
determining an affine fit based on the set of keypoint matches;
determining a protective fit based on the set of keypoint matches;
generating a projection matrix based on the affine fit and the projective fit; and
adjusting the set of keypoint matches based on the projection matrix.

4. The method of claim 3, wherein the calibration data includes the projection matrix.

5. The method of claim 3, wherein determining an affine fit based on the set of keypoint matches determines a roll estimate, pitch estimate, and scale estimate.

6. The method of claim 3, wherein determining the projective fit determines a yaw estimate.

7. The method of claim 3, further comprising adjusting the stereoscopic image pair based on the adjusted set of keypoint matches.

8. The method of claim 3, further comprising determining new vertical disparity vectors based on the adjusted set of keypoint matches and further adjusting the set of keypoint matches if the new vertical disparity vectors indicate a disparity above a threshold.

9. The method of claim 8, wherein the adjusting of the set of keypoint matches and determining new vertical disparity vectors are iteratively performed until the new vertical disparity vectors indicate a disparity below a threshold.

10. The method of claim 1, wherein the method is performed in response to the output of an accelerometer exceeding a threshold.

11. The method of claim 1, wherein the method is performed in response to an autofocus event.

12. The method of claim 1, wherein the evaluating of the quality of the keypoint constellation includes determining the distance between keypoints.

13. The method of claim 1, wherein evaluating the quality of the keypoint constellation comprises determining the distance of each keypoint to an image corner.

14. The method of claim 1, wherein evaluating the quality of the keypoint constellation comprises determining the number of keypoint matches.

15. The method of claim 1, wherein the evaluating of the quality of the keypoint constellation comprises determining a sensitivity of one or more estimates derived from the keypoint constellation to perturbations in the keypoint locations.

16. The method of claim 1, further comprising pruning the set of keypoint matches based on the location of each keypoint match to remove one or more keypoint matches from the set of keypoint matches.

17. An imaging apparatus, comprising:
a first imaging sensor;
a second imaging sensor;
a sensor control module, configured to capture a first image of a first stereoscopic image pair from the first imaging sensor, and to capture a second image of the first stereoscopic image pair from the second imaging sensor;
a keypoint module, configured to determine a set of key point matches between the first image and the second image;
a keypoint quality module, configured to evaluate the quality of the set of key point matches to determine a key point constellation quality level;
and
a master control module, configured to compare the keypoint constellation quality level to a predetermined threshold, and if the keypoint constellation quality level is above the predetermined threshold, adjust the stereoscopic image pair based on the keypoint constellation.

18. The apparatus of claim 17, wherein the keypoint quality module determines the keypoint constellation quality level based, at least in part, on the position of keypoints matches in the keypoint constellation within the first image and the second image.

19. The apparatus of claim 17, wherein the keypoint quality module determines the keypoint constellation quality level based, at least in part, on a variation in angle estimates generated based on the keypoint constellation, and on a noisy keypoint constellation based on the keypoint constellation.

20. The apparatus of claim 17, wherein the noisy keypoint constellation is generated based, at least in part, by adding random noise to at least a portion of keypoint locations for keypoints in the keypoint constellation.

21. The method of claim 17, wherein the master control module is configured to compare the keypoint constellation quality level to a predetermined threshold in response to the output of an accelerometer exceeding a threshold.

22. The method of claim 17, wherein the master control module is configured to compare the keypoint constellation quality level to a predetermined threshold in response to an autofocus event.

23. A stereoscopic imaging device, comprising:
a first image sensor configured to capture a first image of a stereoscopic image pair;
a second image sensor configured to capture a second image of the stereoscopic image pair;
means for determining a set of key point matches based on the first image and the second image, the set of keypoint matches comprising a keypoint constellation;
means for evaluating the quality of the keypoint constellation to determine a key point constellation quality level;
means for determining if the key point constellation quality level exceeds a predetermined threshold;
means for generating calibration data based on the keypoint constellation if the threshold is exceeded; and
means for storing the calibration data to a non volatile storage device.

24. The device of claim 23, wherein the means for generating calibration data based on the keypoint constellation generates the calibration data by
determining one or more vertical disparity vectors between keypoints in the one or more keypoint matches in the set of keypoint matches,
determining a vertical disparity metric based on the one or more vertical disparity vectors,
comparing the vertical disparity metric to a threshold, and
if the vertical disparity metric is above the threshold, determining keypoint match adjustments based at least in part on the set of keypoint matches.

25. The device of claim 23, wherein the keypoint constellation quality level is determined by determining a sensitivity of one or more estimates derived from the keypoint constellation to perturbations in the keypoint locations.

26. The device of claim 23, wherein the means for determining if the key point constellation quality level exceeds a predetermined threshold includes means for determining the distance between keypoints.

27. The device of claim 23, wherein the means for evaluating the quality of the keypoint constellation comprises means for determining the distance of each keypoint to an image corner.

28. A non-transitory computer readable medium, storing instructions that when executed by a processor, cause the processor to perform the method of
capturing a first image of a scene of interest with a first image sensor;
capturing a second image of the scene of interest with a second image sensor, wherein the first image and second image comprise a stereoscopic image pair;
determining a set of key point matches based on the first image and the second image, the set of keypoint matches comprising a keypoint constellation;
evaluating the quality of the keypoint constellation to determine a key point constellation quality level; and
determining if the key point constellation quality level exceeds a predetermined threshold, wherein if the threshold is exceeded, generating calibration data based on the keypoint constellation and storing the calibration data to a non-volatile storage device.
